(19) United States
(12) Patent Application Publication
(10) Pub. No.: US 2026/0187616 A1
(43) Pub. Date: Jul. 2, 2026

(54) SYSTEMS AND METHODS FOR MANAGING FAILED CONTACT-BASED AND CONTACTLESS TRANSACTIONS

(71) Applicants: American Express Travel Related Services Company, Inc., New York, NY (US); American Express Services Europe Limited, London (GB); AMEX Canada, Inc., North York (CA)

(72) Inventors: Indiana Maria Baltodano, New York, NY (US); Manik Biswas, Burgess Hill (GB); Ashley Sjostrom Brailey, Garwood, NJ (US); Alaric M. Eby, Scottsdale, AZ (US); Ajay Babu Maddukuri, Phoenix, AZ (US); Magdalena McGoldrick, East York (CA); Mukund Shankar SimhaRaghu, Glendale, AZ (US)

(21) Appl. No.: 19/001,661

(22) Filed: Dec. 26, 2024

(51) Int. Cl. G06Q 20/32; G06Q 20/20; G06Q 20/22

(52) U.S. Cl. CPC G06Q 20/3278; G06Q 20/204; G06Q 20/227

(57) ABSTRACT

Various embodiments are described relating to systems and methods of managing failed contactless transactions. In one examples, a system comprises a payment device that is configured to initiate a transaction with a first wireless-enabled point-of-sale (POS) device and generate a payment credential for the transaction. The payment credential is transmitted to the wireless-enabled POS device. A transaction error is generated based at least in part on an error code received from the wireless-enabled POS device or an expiration of a time out period. The transaction error comprises an identifier for the wireless-enabled POS device and store the transaction error in the memory.

### BACKGROUND

Contactless transactions have provided a convenient and secure manner for executing purchases wirelessly with a payment device. Some examples of contactless transactions can include contactless payment cards equipped with a near field communication (NFC) transceiver, a mobile phone equipped with a NFC transceiver, a wearable device with equipped with an NFC transceiver, Quick Response (QR) code payments, biometric payments, and other suitable contactless mechanisms. Occasionally, these contactless payment mechanisms cannot complete a transaction for one or more reasons.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting a scenario of a network environment according to various embodiments of the present disclosure.

FIG. 2 is a drawing of the network environment according to various embodiments of the present disclosure.

FIG. 3 is a flowchart illustrating one example of functionality implemented as portions of an application executed in a computing environment in the network environment of FIG. 2 according to various embodiments of the present disclosure.

FIG. 4 is a flowchart illustrating one example of functionality implemented as portions of an application executed in a computing environment in the network environment of FIG. 2 according to various embodiments of the present disclosure.

FIG. 5 is a sequence diagram illustrating one example of functionality implemented as portions of an application executed in a computing environment in the network environment of FIG. 2 according to various embodiments of the present disclosure.

FIG. 6 is a sequence diagram illustrating one example of functionality implemented as portions of an application executed in a computing environment in the network environment of FIG. 2 according to various embodiments of the present disclosure.

FIG. 7 a flowchart illustrating one example of functionality implemented as portions of a service executed in a computing environment in the network environment of FIG. 2 according to various embodiments of the present disclosure.

### DETAILED DESCRIPTION

The various embodiments of the present disclose related to systems and methods of managing failed transactions which involved either contact or contactless payment protocols. The various embodiments can be used to identify malfunctioning point-of-sale (POS) devices, initiate alternative payment options when a contact or contactless payment fails, generate merchant notifications relating to a failed transaction, and/or other suitable functionality.

For example, when user attempts to conduct a contact or contactless payment, such as an Europay, Mastercard, and Visa (EMV) dip or an NFC tap with a payment card on a POS device, the transaction process often involves a two-way data communication between the two devices. For instance, during a contact or contactless failure, a POS device can generate or identify a transaction error from the attempted transaction. As a result, the POS device has transaction error data from the attempted transaction, but the payment device and the payment network may not receive any data on why the contact or contactless transaction failed. Further, even if the payment device was aware of the transaction failure, the payment device does not execute a subsequent action relating to the failure.

Accordingly, the various embodiments of the present disclosure provide several advantages over existing methods of handling contact and contactless payment protocol failures. For example, the existing methods do not manage contact or contactless transaction failures from a payment device perspective (e.g., a user perspective). Additionally, during a payment failure, the operator of the POS device and/or the payment network do not provide functionality for handling contact and/or contactless payments. In the context of the present disclosure, contact and contactless payment protocols are distinguishable from traditional payment methods because these payment protocols can generate transaction error data that can be used for managing failed transactions. Existing methods and payment devices do not capture the transaction error data (e.g., enriched error data) from individual POS devices and execute functionality in real-time relating to the transaction failure. For example, the various embodiments of the present disclosure can involve executing an alternate payment credential in response to a contactless transaction error from the POS device. In other examples, the various embodiments of the present disclosure can transmit a real-time notification to a mobile device that is anticipated to be involved in a transaction. The real-time notification can include a recommended payment option (e.g., a recommended payment instrument, a recommended transaction type) based at least in part on a history of contact and/or contactless transaction errors at a specific POS device.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

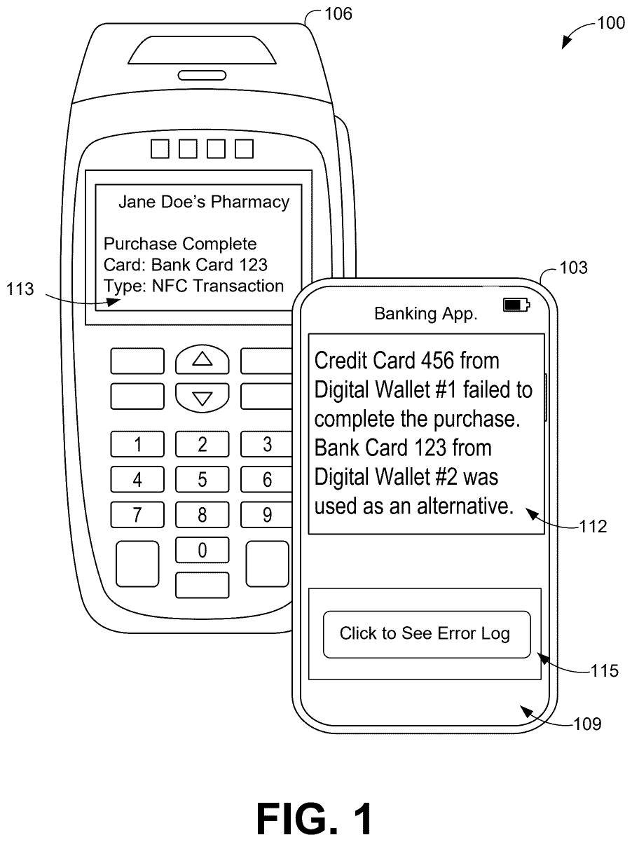

As illustrated in FIG. 1, shown is an example scenario of a transaction error for a first contactless payment option occurring and an alternative contactless payment option being executed to complete the transaction in a network environment 100. The network environment 100 includes a payment device 103 (e.g., a client device) and a point-of-sale (POS) device 106. In the illustrated FIG. 1, the payment device 103 is attempting to execute a contactless transaction with the POS device 106 for a purchase. In this non-limiting example, the payment device 103 and the POS device 106 are using a near-field communication (NFC) protocol for the contactless transaction.

In the payment device 103, a user interface 109 of a banking application (e.g., a client application) is shown. The use interface 109 can include a transaction status 112 and an error log 115. In the illustrated example, the transaction status 112 indicates that a first contactless payment option of “Credit Card 456 from Digital Wallet #1” was attempted via the NFC protocol. However, the first contactless payment option failed to complete the NFC transaction with the POS device 106. The transaction status 112 further indicates that a second contactless payment option was automatically attempted and successful after the first contactless payment option failed. The second contactless payment option was “Bank Card 123 from Digital Wallet #2.” Thus, the transaction status 112 indicates that upon determining that the first contactless payment option has failed, the banking application identified a second contactless payment option to apply during the NFC transaction.

In this example, the banking application identified the second contactless payment option from a second wallet application wherein the first contactless payment option was stored in a first wallet application. As such, during a single NFC session, the first contactless payment option failed, and a second contactless payment option was successful. The POS device 106 displays on a merchant user interface 113 which indicates that the second contactless payment option was used for a successful transaction.

In some examples, the banking application or another client application can have a configuration setting (e.g., a device setting, a wallet setting, etc.) for configuring a second contactless payment option (e.g., a second payment instrument) to be used in the event of a contactless transaction failure. The configuration setting can be configured for identifying a second payment instrument in the same wallet application or a different wallet application, as shown in FIG. 1. The configuration setting can be configured for other types of payment instruments as will described.

The error log 115 can represent a user interface component that can be selected to view detailed information relating to one or more transaction failures. For example, the error log 115 can display detailed information, such as an unsupported wireless transceiver (e.g., NFC transceiver, Bluetooth transceiver, etc.) for POS device 106, malfunctioning POS device 106, a null response from POS device 106, a general error code, an interference error, or other suitable transaction errors. The error log 115 can represent a history of transaction errors that have occurred with POS device 106. The POS device 106 can transmit the transaction errors to the payment device 103. In some examples, the transaction errors can be generated in accordance to a contactless payment protocol (e.g., a version of the Europay, MasterCard, and Visa (EMV) standard) and a contactless data communication protocol (e.g., a version of the NFC protocol, a version of the BLUETOOTH protocol, etc.).

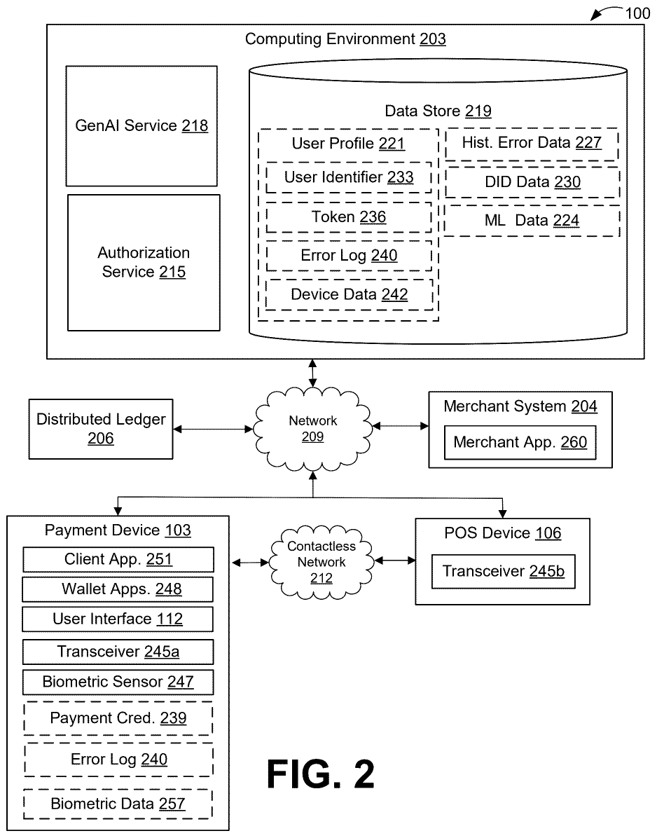

With reference to FIG. 2, shown is a network environment 200 according to various embodiments. The network environment 200 can include a payment device 103, a POS device 106, a computing environment 203, a merchant system 204, and a distributed ledger 206, which can be in data communication with each other via a network 209.

The network 209 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 209 can also include a combination of two or more networks 209. Examples of networks 209 can include the Internet, intranets, extranets, virtual private networks (VPNs), and similar networks.

The payment device 103 (e.g., a client device, a payment card, a wearable device, etc.) and the POS device 106 can be in data communication by way of a contactless network 212. The contactless network 212 can enable direct communication between the payment device 103 and the POS device 106 without the involvement of the network 209. In some examples, the contactless network 212 can represent one or more near field communication (NFC) protocols, one or more BLUETOOTH protocols, and other suitable local contactless networks 212. The contactless network 212 can be used to execute a contactless payment. One non-limiting examples of contactless payment would be according to a version of the Europay, Mastercard, and Visa (EMV) contactless payment standard.

The computing environment 203 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 203 can employ a plurality of computing devices that can be arranged in one or more server banks or computer banks or other arrangements. Such computing devices can be located in a single installation or can be distributed among many different geographical locations. For example, the computing environment 203 can include a plurality of computing devices that together can include a hosted computing resource, a grid computing resource, a cloud computing resource, or any other distributed computing arrangement. In some cases, the computing environment 203 can correspond to an elastic computing resource where the allotted capacity of processing, network, storage, or other computing-related resources can vary over time.

Various applications or other functionality can be executed in the computing environment 203. The components executed on the computing environment 203 include an authorization service 215, a generative artificial intelligence (GenAI) service 218, and other applications, services, processes, systems, engines, or functionality not discussed in detail herein.

The authorization service 215 can be executed to manage failed contactless transactions. In some examples, the authorization service 215 can be used to collect error log data from payment devices 103, POS devices 106, and other suitable devices. The error log data can be used by the authorization service 215 to identify malfunctioning POS devices 106 for contactless transaction or a POS device 106 without contactless hardware and software.

The GenAI service 218 can be executed to collect or aggregate error log data. The GenAI service 218 can generate recommendations and transmit notifications for these recommendations to merchant relating to the failed transaction errors and recommendations to the payment devices 103 relating to suggested payment instruments to use at the POS device 106. The GenAI service 218 can be executed to train, generate, validate, test, and deploy machine learning models (e.g., GenAI models such as large language models, etc.) to assist generating recommendations and transmitting notifications based at least the error log 240 and/or the historical error data 227. The GenAI service 218 can train the machine learning models for analyzing the information for failed contactless payments.

The GenAI service 218 can be executed to receive prompts, process the prompts, and return responses to the prompts based on a machine learning model that has been trained. Accordingly, the GenAI service 218 could act as a front-end to the machine learning model for the authorization service 215. In some instances, the GenAI service 218 could provide an API which could be used to programmatically receive prompts and return responses.

Also, various data is stored in a data store 219 that is accessible to the computing environment 203. The data store 219 can be representative of a plurality of data stores 219, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 219 is associated with the operation of the various applications or functional entities described below. This data can include user profiles 221, machine learning data 224, historical error data 227, decentralized identifiers (DID) data 230, and potentially other data.

The user profile 221 can represent a user account or profile for each user associated with the network environment 100. The user profile 221 can include a user identifier 233, a token 236, an error log 240, a device data 242, and other suitable data.

The user identifier 233 can represent a unique identifier for each user associated with the network environment 100. The token 236 (e.g., a token identifier) can represent a unique identifier for each payment device 103 for a user. For example, a first token 236 can represent a payment instrument accessible to a mobile device (e.g., a first payment device 103), and a second token 236 can represent a payment card (e.g., a second payment device 103).

The error log 240 can represent data associated with a log of failed contactless transactions for a user profile 22. The error log 240 can include a history of failed contactless transactions, such as a time stamp, a transaction location, a contactless type, a merchant identifier, a purchase amount, remediation type, an unsupported wireless transceiver (e.g., NFC transceiver, Bluetooth transceiver, etc.) for POS device 106, a malfunctioning POS device 106, a lack of a response from the POS device 106, a general error code, an interference error, and other suitable errors. In some examples, the errors can be generated in accordance to a contactless payment protocol (e.g., a version of the EMV standard) and/or a contactless data communication protocol (e.g., a version of the NFC protocol, a version of the BLUETOOTH protocol, etc.).

The device data 242 can include an identifier for a computing device associated with the user and other suitable device data related to the computing device associated with the user. For example, the device data 242 can include a phone number, an Internet Protocol (IP) address, an operating system identifier, an operating system type, a device type, and other suitable device.

The machine learning data 224 can represent data associated with generating, validating, and deploying machine learning models (e.g., GenAI models such as large language models) used for collecting and analyzing error logs 240 (e.g., error data associated with individuals) and historical error data 227 (e.g., error data associated with a set of individuals). For example, machine learning models can be generated and used by the authorization service 215 to generate recommendations and transmit notifications.

In some examples, the machine learning models are GenAI models (e.g., large language models (LLMs)). The authorization service 215 can submit a request to the GenAI service 218 for generating a recommendation and/or transmitting a notification relating to the failed contactless transactions for a merchant and/or a user. The authorization service 215 can use prompt engineering or other augmentation techniques to improve the quality of the response from the GenAI service 218.

The historical error data 227 can represent error data for failed contactless transactions for multiple users over a period of time. The historical error data 227 can be partitioned into different subset of individual users, different geographic areas, another suitable categories. The error logs 240 from multiple user profiles 221 can be accumulated as the historical error data 227. The historical error data 227 can include data from other supplemental data sources.

In some examples, the historical error data 227 can be used by the GenAI service 218 and/or the authorization service 215 to generate recommendations for the merchants and/or users regarding failed contactless transactions. The recommendations can be transmitted via one or more notification to a merchant system or a payment device 103 of a user.

The DID data 230 can correspond to one or more decentralized identifiers (DID) that enables verifiable, decentralized digital identity of a subject (e.g., person, organization, thing, etc.). In some examples, a DID can be used to represent the identity of a user, a payment device 103, and other suitable subjects. In various examples, a DID can correspond to an address to a DID document that includes information associated with the subject (e.g., a user, a payment device 103, etc.). In various examples, the DIDs can be implemented using various standards, such as a version of the World Wide Web Consortium's (W3C's) Decentralized Identifier (DID) standard. The DID data 230 can also include a verifiable credential. The verifiable credential can represent a digital credential that has been issued by a third party.

The payment device 103 can be a client device or a payment card that can communicate via the contactless network 212. In some examples, the payment device 103 is representative of a plurality of client devices that can be coupled to the network 209 and/or the contactless network 212. In some examples, the payment device 103 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The payment device 103 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the payment device 103 or can be connected to the payment device 103 through a wired or wireless connection.

The payment device 103 can include a transceiver 245a, a biometric sensor 247, and other suitable devices. The transceiver 245a can represents one or more components that communicate according to various wireless communication protocols, such as over the network 209 and/or the contactless network 212. Accordingly, the payment device 103 can represent a wireless-enabled mobile device (e.g., an NFC-enabled mobile device) or wireless-enabled payment card (e.g., an NFC-enabled payment card). For example, the transceiver 245a can represent a near field communication (NFC) transceiver that communicates according to one or more NFC communication protocols or over the contactless network 212. In this instance, the contactless network 209 can represent one or more NFC communication protocols that are used to execute a contactless data transaction between the payment device 103 and the POS device 106. Additionally, the transceiver 245a can represent other wireless transceivers, such as a Wi-Fi transceiver, a cellular transceiver, a BLUETOOTH transceiver, and others suitable wireless transceivers.

The biometric sensor 247 can represent one or more devices for verifying the identity of a user. For example, the biometric sensor 247 can perform a biometric scan, such as a facial scan, a fingerprint scan, a palm scan, an audible scan (e.g., an audible recording), and other suitable biometric scans. Some non-limiting examples of biometric sensor 247 can include a camera, a fingerprint scanner, a microphone, and other suitable sensors. The biometric scans can be compared to a stored biometric scan associated with the user identify 233.

The payment device 103 can be configured to execute various applications such as a wallet application 248, a client application 251 or other applications. The wallet application 248 can be executed in the payment device 103 to facilitate a completion of a contactless transaction. The wallet application 248 can access one or more payment instruments, payment credentials, and other suitable payment data for executing a contactless payment.

In some examples, the client application 251 can represent a banking application, peer-to-peer transfer application, and other suitable applications. The client application 251 can be executed in a payment device 103 to access network content served up by the computing environment 203 or other servers, thereby rendering a user interface 109 on the display. To this end, the client application 251 can include a browser, a dedicated application, or other executable, and the user interface 109 can include a network page, an application screen, or other user mechanism for obtaining user input. The payment device 103 can be configured to execute applications beyond the client application 251 such as email applications, social networking applications, word processors, spreadsheets, or other applications.

The payment device 103 can access data for managing transaction errors and executing contactless payments. Also, various data is stored in the payment device 103 that is accessible to the executable applications. The data stored within the payment device 103 can include payment credentials 254, the error log 240, the biometric data 257, and other suitable data.

The payment credentials 254 can include data for executing contactless payments. The payment credentials 239 can include tokens 236 for payment instruments (e.g., credit card, debit card, gift card, etc.), DID data 230 (e.g., DIDs), and other suitable payment credential data.

The error log 240 can represent data associated with a log of failed contactless transactions for a user profile 22. The client application 251 and/or the wallet application 248 can generate and store data for the error log 240 based at least in part on failed contactless transactions with the POS device 106

The biometric data 257 can include stored biometric scan data used to verify the identity of a user attempting to execute a contactless payment. The biometric sensor 247 can perform a biometric scan of the user, and the biometric scan can be compared to one or more stored biometric scans in the payment device 103. For example, if the payment device 103 is a mobile device, the biometric sensor 247 can be a camera for taking facial scans. If the payment device 103 is a payment card, the biometric sensor 247 can be a fingerprint scanner. The stored biometric scans can include facial scans, fingerprint scans, audible scans, palm scans, and other suitable biometric scans.

The POS device 106 can represent a device that is configured for executing a contactless transaction with the payment device 103. The POS device 106 can include a transceiver 245b for data communications. The transceiver 245b can represents one or more components that communicate according to various wireless communication protocols, such as over the network 209 and/or the contactless network 212. For example, the transceiver 245b can represent a near field communication (NFC) transceiver that communicates according to one or more NFC communication protocols or over the contactless network 212. Additionally, the transceiver 245b can represent other wireless transceivers, such as a Wi-Fi transceiver, a cellular transceiver, a BLUETOOTH transceiver, and others suitable wireless transceivers.

The merchant system 204 can represent a merchant computing environment which can be in data communication with a plurality of POS devices 106 and the computing environment 203 over the network 209. The merchant environment can employ a plurality of computing devices that can be arranged in one or more server banks or computer banks or other arrangements. Such computing devices can be located in a single installation or can be distributed among many different geographical locations. For example, the merchant computing environment can include a plurality of computing devices that together can include a hosted computing resource, a grid computing resource, a cloud computing resource, or any other distributed computing arrangement.

The merchant system 204 can execute a merchant application 260 to facilitate managing errors for contactless transactions. In some examples, the merchant application 260 can be executed to facilitate alternative processing (e.g., processing an alternative payment credential 239) in the event of a failure to complete a transaction with an initial payment credential 239. In other examples, the merchant application 260 can be involved in collecting transaction error data (e.g., error log 240), historical error data 227, and other suitable data associated failed contactless transactions from the POS devices 106.

The distributed ledger 206 can represent synchronized, eventually consistent, data stores spread across multiple nodes in different geographic or network locations. The distributed ledger 206 can maintain records of communications (e.g., transactions) involving the payment devices 103. In some examples, the distributed ledger 206 can represent a blockchain network or other suitable distributed database systems.

Next, a general description of the operation of the various components of the network environment 100 is provided. Although the following description provides one illustrative example of the operations of and interactions between the various components of the network environment 100, other operations and interactions are also encompassed by the various embodiments of the present disclosure. More detailed discussion of the operations of individual components is provided in the discussion accompanying the subsequent drawings.

To begin, a user can attempt to make a first contactless transaction (e.g., an NFC transaction) at a POS device 106 using a payment device 103 (e.g., an NFC-enabled mobile device) during a contactless data session. During the contactless data session, the wallet application 248 for the payment device 103 can transmit a first payment credential 239 to the POS device 106. However, the first contactless transaction fails and the wallet application 248 receives contactless transaction error data from the POS device 106. The wallet application 248 stores the contactless transaction error data in the error log 240.

During the contactless data session, the wallet application 248 can generate and transmit a second payment credential based at least in part on the contactless transaction error data. In some examples, the second payment credential can be generated from a second token of a second payment instrument associated with the wallet application 238. In other examples, the wallet application 248 can generate the second payment credential based at least in part on a second token from a second wallet application 248 (e.g., an alternative wallet application) executed the payment device 103.

In other examples, the payment device 103 can receive and store the contactless transaction error data from a first POS device 106. At a second POS device 105, the payment device 103 transmit a payment credential for a second transaction and the contactless transaction error data from the first transaction. After the second POS device 105 has confirmed the completion of the second transaction, the contactless transaction error data can be deleted from the memory of the payment device 103.

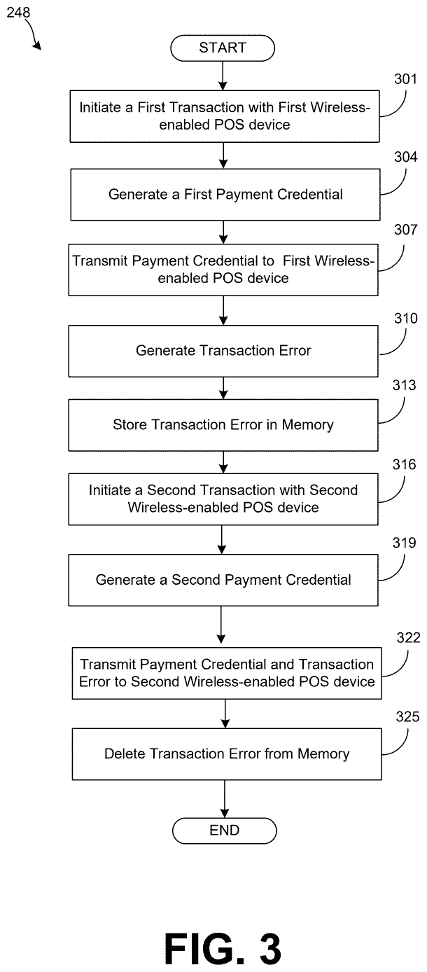

Referring next to FIG. 3, shown is a flowchart that provides one example of the operation of a portion of the wallet application 248. The flowchart of FIG. 3 provides merely an example of the many different types of functional arrangements that can be employed to implement the operation of the depicted portion of the wallet application 248. As an alternative, the flowchart of FIG. 3 can be viewed as depicting an example of elements of a method implemented within the network environment 100. The wallet application 248 can be executed in the payment device 103. In some examples, the payment device 103 can be a client device or a payment card (e.g., NFC-enabled payment card). Additionally, portions of or the entirety of the flowchart of FIG. 3 can be performed by the client application 251.

Beginning with block 301, the wallet application 248 can initiate a first transaction with a first wireless-enabled POS device 106 (POS device 106). The payment device 103 and/or the first POS device 106 can emit a radio signal to initiate the first transaction. For example, the first POS device 106 can emit an (RF) signal that is received by the payment device 103. In some examples, the RF signal can comprise first transaction data related to the first transaction, such as a time stamp, a purchase amount, a contactless transaction type, a geographic location identifier, a merchant and/or store identifier, and other suitable transaction data.

The initiation of the RF signal can represent a first contactless session that is communicated over the contactless network 212 (e.g., according to a contactless protocol standard). For example, the first contactless session can represent a first NFC session that has been initiated between the payment device 103 and the first POS device 106.

In some examples, the client application 251 and/or the wallet application 248 can use a biometric sensor 247 to perform biometric scan. The biometric scan can be performed to verify the identity of the user. The client application 251 and/or the wallet application 248 can compare the biometric scan to a stored biometric scan from the biometric data 257. For example, when the payment device 103 is a mobile device, the biometric sensor 247 can be a camera for generating a facial scan. When the payment device 103 is a payment card, the biometric sensor 247 can be a fingerprint scanner for generating a fingerprint scan. However, in some instances, the biometric sensor 247 is omitted.

In block 304, the wallet application 248 can generate a first payment credential 239 based at least in part on the first transaction data provided by the first POS device 106. In some examples, the first payment credential 239 comprises a token 236 (e.g., token identifier) associated with a particular payment instrument (e.g., a credit card, a debit card, a check card, etc.). In some examples, the first payment credential 239 is a cryptogram generated based at least in part on a cryptogram key stored in the payment device 103. The cryptogram can be generated using a Rivest-Shamir-Adleman (RSA) cryptographic, Digital Signature Algorithm (DSA), elliptic curve cryptography, or other suitable cryptographic algorithms.

In some examples, the first transaction data provided by the first POS device 106 can include an identifier for the first POS device 106, a purchase amount, a geographic location indicator, a time stamp, a transaction date, an unpredictable number, a device type for the first POS device 106, a transaction type, and other suitable transaction data.

In block 307, the client application 251 can transmit the first payment credential 239 to the first POS device 106 using the transceiver 245a. For example, the payment credential 239 is transmitted using the first contactless session (e.g., the NFC session) described above.

In block 310, the wallet application 248 can generate a transaction error based at least in part on an error code received from the first wireless-enabled POS device 106 (e.g., an POS device error code) or an expiration of a time out period. The transaction error comprises an identifier for the first wireless-enabled POS device 106 and other suitable transaction error data.

In some examples, the first POS device 106 can transmit an error code to the wallet application 248 in response to the first payment credential 239. Some non-limiting examples of error codes can include an unsupported wireless tag (e.g., unsupported NFC tag/transceiver), a malfunctioning wireless-enabled POS device 106, a general error condition, an activation conflict, incorrect parameters, wrong data in data field and other suitable a wireless-enabled POS device 106. In some examples, the error codes can be defined to correlate to one or more technical problems.

In some examples, the first POS device 106 can fail to respond or an expiration of a time out period occurs in response to the transmission of the payment credential 239. As such, in some examples, the wallet application 248 can initiate a timer from the transmission of the first payment credential 239.

In some examples, the wallet application 248 can filter out insufficient funds errors received from the first POS device 106 because some embodiments may desire to identify failed contactless interactions. Additionally, the wallet application 248 can include additional data to the transaction error associated with the context of the failed the transaction error, such as a present location of the transaction (e.g., a GPS location), a list of items for purchase, and other suitable context data.

In block 313, the wallet application 248 can store the transaction error in the memory (e.g., in the error log 240). In some examples, the payment device 103 is a mobile device and the client application 251 can store the transaction error in a secure element, an embedded security controller compliant with a security protocol, a payment credential cloud, or in other suitable memory locations. In other examples, the payment device 103 is a wireless-enabled payment card (e.g., NFC-based payment card). In these examples, the wireless-enabled payment card can store the transaction error (e.g., in error log 240) in the available memory on the card.

Alternatively, in some examples, when the payment device 103 is a client device, the wallet application 248 can transmit the transaction error or the error log 240 to the authorization service 215 using an application programming interface (API) call for storage. In this examples, the client application 251 may omit storing the transaction error.

In the context of these examples, the user was unable to complete the contactless transaction at the first wireless-enabled POS device 106. Subsequently, the user can move to a second wireless-enabled POS device 106 (second POS device 106) to execute a second transaction.

In block 316, the wallet application 248 can initiate the second transaction with a second POS device 106. The second transaction may occur at the same merchant location with a second POS device 106 that is different from the first POS device 106 or the second wireless-enabled POS device 106 is located at another merchant location. The second transaction can be initiate with the second POS device 106 as a second contactless session (e.g., a second NFC session) where the transceivers 245a of the payment device 103 and the second POS device 106 are in data communication.

In block 319, the wallet application 248 can generate a second payment credential 239 for the second transaction based at least in part on second transaction data provided by the second POS device 106. In some examples, the second payment credential 239 comprises a token 236 (e.g., token identifier) associated with a particular payment instrument (e.g., a credit card, a debit card, a check card, etc.). In some examples, the second payment credential 239 is a cryptogram generated based at least in part on a cryptogram key stored in the payment device 103. The cryptogram can be generated using a Rivest-Shamir-Adleman (RSA) cryptographic, Digital Signature Algorithm (DSA), elliptic curve cryptography, or other suitable cryptographic algorithms.

In some examples, the second transaction data provided by the second POS device 106 can include an identifier for the second POS device 106, a purchase amount, a geographic location indicator, a time stamp, a transaction date, an unpredictable number, a device type for the second wireless-enabled POS device 106, a transaction type, and other suitable transaction data.

In block 322, the wallet application 248 can transmit the second payment credential for the second transaction and the transaction error for the first transaction to the second POS device 106 using the transceiver 245a. For example, the payment credential 239 is transmitted using the second contactless session (e.g., the second NFC session) described above.

In block 325, the wallet application 248 can delete the transaction error for the first transaction from the memory based at least in part on receiving a confirmation of the second transaction being completed from the second POS device 106. In some examples, the functionality for block 325 can be omitted. For example, when the payment device 103 is a payment card, the memory space may be limited. In contrast, the when the payment device 103 is a mobile device, the memory space can be larger and there may not be a need for deleting the error log 240 after it has been transmitted to the second POS device 106. Then, the wallet application 248 can proceed to the end of the depicted process.

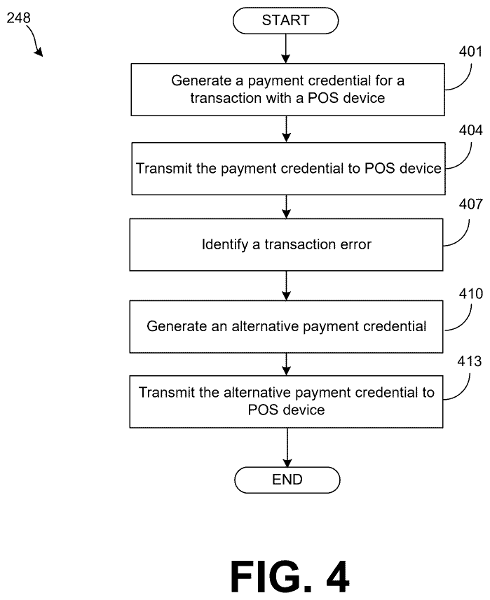

Turning now to FIG. 4, shown is a flowchart that provides one example of the operation of a portion of the wallet application 248. The flowchart of FIG. 4 provides merely an example of the many different types of functional arrangements that can be employed to implement the operation of the depicted portion of the wallet application 248. As an alternative, the flowchart of FIG. 4 can be viewed as depicting an example of elements of a method implemented within the network environment 100. In some examples, portions of or the entirely of the flowchart of FIG. 4 can be executed by the client application 251.

Beginning with block 401, the wallet application 248, using a payment device 103, can generate a payment credential 239 for a transaction with a wireless-enabled POS device 106 (POS device 106). In some examples, the wallet application 248 can initiate a transaction with the POS device 106, in which a contactless session is established between the payment device 103 and the POS device 106. The wallet application 248 can generate the payment credential 239 based at least in part on the initiation of the transaction between the POS device 106 and the wallet application 248.

In some examples, the first payment credential 239 comprises a token 236 (e.g., token identifier) associated with a particular payment instrument (e.g., a credit card, a debit card, a check card, etc.). In some examples, the first payment credential 239 is a cryptogram generated based at least in part on a cryptogram key stored in the payment device 103. The cryptogram can be generated using a Rivest-Shamir-Adleman (RSA) cryptographic, Digital Signature Algorithm (DSA), elliptic curve cryptography, or other suitable cryptographic algorithms.

In some examples, the first transaction data provided by the first POS device 106 can include an identifier for the first POS device 106, a purchase amount, a geographic location indicator, a time stamp, a transaction date, an unpredictable number, a device type for the first POS device 106, a transaction type, and other suitable transaction data.

In block 404, the wallet application 248 can transmit the payment credential 239 to the POS device 106 using a transceiver 245a of the payment device 103. For example, the payment credential 239 is transmitted using the contactless session (e.g., the NFC session) described above.

In block 407, the wallet application 248 can identify a transaction error based at least in part on an error code received from the wireless-enabled POS device 106 or an expiration of a time out period from the transmission of the payment credential 239. The transaction error comprises an identifier for the first wireless-enabled POS device 106 and other suitable transaction error data.

In some examples, the POS device 106 can transmit an error code to the wallet application 248 in response to the payment credential 239. Some non-limiting examples of error codes can include an unsupported wireless tag (e.g., unsupported NFC tag/transceiver), a malfunctioning wireless-enabled POS device 106, and other suitable POS device error codes.

In some examples, the POS device 106 can fail to respond or an expiration of a time out period occurs in response to the transmission of the payment credential 239. As such, in some examples, the wallet application 248 can initiate a timer from the transmission of the payment credential 239.

In some examples, the wallet application 248 can filter out insufficient funds errors received from the first wireless-enabled POS device 106 because some embodiments may desire to identify failed contactless interactions. Additionally, the wallet application 248 can include additional data to the transaction error associated with the context of the failed the transaction error, such as a present location of the transaction (e.g., a GPS location), a list of items for purchase, and other suitable context data.

In block 410, the wallet application 248 can generate an alternative payment credential 239 based at least in part on the transaction error. The wallet application 248 can generate the alternative payment credential 239 using various payment instruments associated with the user profile 221.

In some examples, the alternative payment credential 239 is another token 236 (e.g., a second token 236) which can be sourced from the wallet application 248 (e.g., a first wallet application 248) or can be sourced from a different wallet application 248 (e.g., a second wallet application 248).

In some examples, the alternative payment credential 239 involves selecting a decentralized identifier (DID) (e.g., from DID data 230 stored in the payment device 103). The DID can be linked to a payment instrument. As such, the wallet application 248 can generate the alternative payment credential 239 that includes a DID which is linked to a payment instrument.

In some examples, the wallet application 248 can determine which alternative payment credential 239 to retrieve based at least in part on one or more wallet settings or other conditions. For example, the wallet settings or conditions can involve transaction data, such as purchase category, a purchase amount, a geographic transaction location, and other suitable transaction data.

In block 413, the wallet application 248 can transmit the alternative payment credential 239 to the POS device 106 using the transceiver 245a of the payment device 103. In some examples, the wallet application 248 can transmit the payment credential 239 and the alternative payment credential 239 during a single contactless session.

In other examples, the wallet application 248 can transmit the alternative payment credential 239 using a second contactless session which is subsequent to the first contactless session that failed. In these examples, the wallet application 248 can determine a failure occurred for the first contactless session using the payment credential 239 for an identifier for the POS device 106. During the initiation of the second contactless session, the wallet application 248 can identify a failure occurred for the identifier of the POS device 106 using the payment credential 239. As such, the wallet application 248 can generate and transmit the alternative payment credential 239 to the POS device 106. Then, the wallet application 248 can proceed to the end of the depicted process.

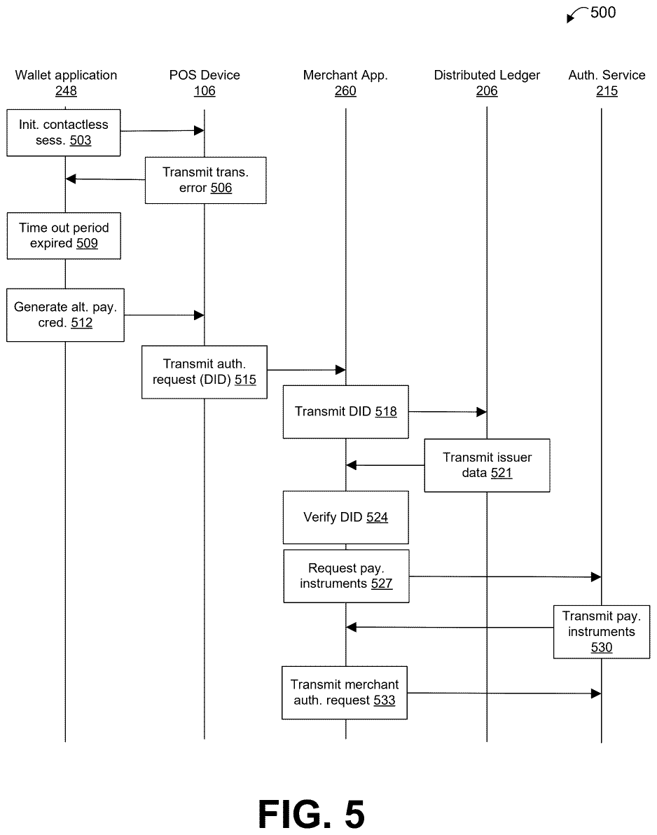

Moving on to FIG. 5, shown is a sequence diagram 500 that provides one example of the operation of a portion of the network environment 100. The sequence diagram 500 of FIG. 5 provides merely an example of the many different types of functional arrangements that can be employed to implement the operation of the depicted portion of the network environment 100. As an alternative, the sequence diagram 500 can be viewed as depicting an example of elements of a method implemented within the network environment 100.

Beginning with block 503, the wallet application 248 can initiate a contactless session (e.g., an NFC session) with a POS device 106 for a transaction. During the contactless session, the wallet application 248 can transmit a payment credential 239 to the wireless-enabled POS device 106 (POS device 106) for executing the transaction.

In block 506, the POS device 106 can be configured to transmit a transaction error to the wallet application during the contactless session. The POS device 106 can generate the transaction error for various conditions, such as an incompatible contactless protocol (e.g., unsupported NFC tag) used by the wallet application 248, an interference condition during the contactless session, a general error, and other suitable contactless error conditions. Upon the determination of the transaction error, the POS device 106 can transmit the transaction error to the wallet application 248. In some examples, the functionality for block 506 can be omitted because the POS device 106 can fail to respond.

In block 509, the wallet application 248 can also determine a time out period has expired since the transmission of the payment credential 239 to the POS device 106. In these examples, the wallet application 248 does not receive a transaction error from the POS device 106.

In block 512, the wallet application 248 can transmit a request for alternative payment credentials 239 that are accepted by the POS device 106 based at least in part on the expiration of the time out period or based at least in part on the transaction error received from the POS device 106. In response, the POS device 106 can transmit to the wallet application 248 one or more acceptable alternative payment credentials 239. In some examples, the acceptable alternative payment credentials 239 may be a different transaction type from the initiate payment credential 239.

For example, the remaining portions of the sequence diagram 500 illustrate a decentralized identifier (DID) that is used to refer to a financial account owned by the user of the wallet application 248. The DID can correspond to an identifier that enables verifiable, decentralized digital identity of a subject (e.g., person, organization, thing, etc.). In some examples, the DID acts like a web address for a digital identity of the subject. The DID can include a verifiable credential, which can include a digital signature for authenticity and integrity of the verifiable credential.

In some examples, the DID can be used to represent the identity of a user, the payment device 103, and other suitable subjects. In various examples, a DID can correspond to an address to a DID document that includes information associated with the subject (e.g., a user, a payment device 103, etc.). In various examples, the DID can be implemented using various standards, such as a version of the World Wide Web Consortium's (W3C's) Decentralized Identifier (DID) standard.

The wallet application 248 can select the DID payment credential 239 among other available options. In some examples, the wallet application 248 can select the DID or other options based at least in part on the transaction error data, a merchant identifier for the transaction, user preferences, and other suitable data. For example, the wallet application 248 can select one of the acceptable payment credentials 239 that optimize savings, reward points, a user preference, merchant conditions (e.g., history of transaction failures), or other conditions.

Accordingly, in this example, the wallet application 248 can generate an alternative payment credential 239 based at least in part on the selection of an DID payment method. Further, the wallet application 248 can generate a cryptogram or other similar encrypted code based at least in part on a cryptogram key and transaction data (e.g., time stamp, transaction amount, merchant identifier, transaction date, etc.).

In this exemplary sequence diagram, the wallet application 248 retrieves a DID from the DID data 230, in which the DID is associated with a payment instrument for the user. In some examples, the wallet application 248 can generate a cryptogram based at least in part on a cryptogram key. The wallet application 248 can transmit the cryptogram and the DID as the alternative payment credential 239.

In block 515, the POS device 106 can transmit an authorization request to the merchant application 260. The authorization request can include at least the DID and other data, such as the cryptogram, transaction data, and other suitable authorization data.

In block 518, the merchant application 260 can transmit the DID to the distributed ledger 206 for retrieving issuer data associated with the DID. The issuer data can include a public key associated with the DID. The merchant application 260 can retrieve the public key to verify a digital signature of the DID was generated by a valid issuer of the DID.

In block 521, the distributed ledger 206 can transmit the issuer data associated with the DID, such as the public key associated with the DID based at least in part on receiving the DID. The distributed ledger 206 can access the DID document that includes the issuer data. The DID document is associated with the DID. In some examples, a DID resolver service can be used to look up the DID and return the corresponding DID document.

In block 524, the merchant application 260 can verify DID using the public key. The merchant application 260 can verify the digital signature associated with the DID using the public key retrieved from the distributed ledger 206. The merchant application 260 can determine a user identifier for the DID (e.g., associated with a user profile at a financial entity) and a routing location address (e.g., a computing device associated with the financial account). The merchant application 260 can use the user identifier and the routing location address (e.g., a server address, a uniform resource location (URL), an Internet Protocol (IP) address) for processing the transaction.

In block 527, the merchant application 260 can request payment instruments (e.g., a bank account number, a savings account, a brokerage account, a debit card account, a credit card account, etc.) associated with the DID (e.g., the verifiable credential) based at least in part on the user identifier and/or the routing location address. In this example, the merchant application 260 can use user identifier and/or the routing location address to communicate with the authorization service 215.

In block 530, the authorization service 215 can transmit the payment instruments associated with the user identifier and/or the DID. Upon verifying the request, the authorization service 215 can transmit one or more payment instrument identifiers (e.g., a token 236, a financial account identifier). In some examples, the verification of the DID can provide authorization to use one or more payment instruments.

In block 533, the merchant application 260 can transmit the authorization request to the authorization service 215 for processing the transaction. The authorization request can include a payment instrument and the transaction data (e.g., a purchase amount, a merchant identifier, a transaction date, transaction time). Then, the wallet application 248 can proceed to the end of the depicted process.

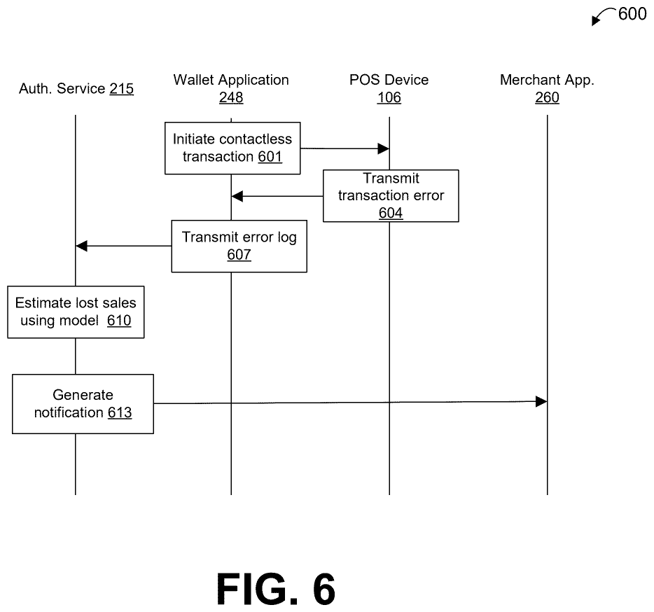

Moving on to FIG. 6, shown is a sequence diagram 600 that provides one example of the operation of a portion of the network environment 100. The sequence diagram 600 of FIG. 6 provides merely an example of the many different types of functional arrangements that can be employed to implement the operation of the depicted portion of the network environment 100. As an alternative, the sequence diagram 600 can be viewed as depicting an example of elements of a method implemented within the network environment 100.

Beginning with block 601, the wallet application 248 can initiate a contactless transaction with a POS device 106 at a merchant location. The contactless transaction can be initiated based at least in part on the contactless network 212. For example, the transaction can be conducted during an NFC session. The wallet application 248 can transmit a payment credential 249 to the POS device 106 based at least in part on transaction data provided by the POS device 106.

In block 604, the POS device 106 can transmit a transaction error to the wallet application 248. The transaction error can include an identifier for the POS device 106 and one or more error indicators such as, an unsupported transceiver for POS device 106, a malfunctioning POS device 106, a general error code, and other suitable transaction error data. In other examples, the POS device 106 could fail to response to the payment credential 249 provided by the wallet application 248. The wallet application 248 can determine no response has been received after an expiration of a time out period. In some examples, the transaction error is stored in error log 240, which may aggregate transaction errors from two or more transaction failures.

In block 607, the wallet application 248 can transmit the error log 240 or the transaction error to the authorization service 215. The authorization service 215 can identify merchant identifiers associated with the error log 240, identifiers for the POS device 106, or the transaction error for the attempted transactions.

In block 610, the authorization service 215 can generate an estimate of lost sales using the GenAI service 218. The GenAI service 218 can interface with a GenAI model which has been trained for estimating lost sales for a merchant. The GenAI service 218 can provide one or more input parameters such as a merchant identifier, a transaction location, a transaction item for purchase, a transaction time, an item category, a user profile 221, and other suitable parameters. The GenAI model can provide an estimate lost sales value and a merchant recommendation. The merchant recommendation can encourage a merchant to take an action that will help the merchant achieve the estimated lost sales, such as using a particular contactless POS device, accept certain payment instruments, and other suitable data. For example, the merchant recommendation can include a suggestion to use a particular type of POS device 106 (e.g., a POS device that has less failures, a POS device with certain contactless features, etc.), accept a payment instrument from a particular financial service provider, and other suitable recommendations.

In some examples, the authorization service 215 can use the GenAI service 218 to aggregate the contactless transaction error data and extrapolate the estimate of lost sales for one or more merchants. In some examples, the GenAI service 218 interfaces with a GenAI model and the GenAI model may consider one or more parameters. In some examples, the GenAI model can be configured to identify a set of lookalike merchants that are similar to the merchant identifier. The GenAI model can identify a set of lookalike merchants similar to a particular merchant being considered for recommendation. Based at least in part on the set of lookalike merchants, the GenAI model can generate an estimate of lost sales. Some of the non-limiting examples of parameters can include merchant spend rate, user spend rates, transaction time, transaction types, transaction location, and other suitable parameters.

In block 613, the authorizations service 215 can generate and transmit a notification to the merchant application 260. The notification can include the estimated lost sales value and the merchant recommendation. The notification can be transmitted based at least in part on looking up a device identifier (e.g., a phone number, an IP address, etc.) or a contact address (e.g., an email address, a mailing address).

In some examples, the authorization service 215 can use the GenAI service 218 to generate the text context for the notification. The authorization service 215 can use a prompt template associated with merchant identifier. The authorization service 215 can insert the estimate of lost sales into a placeholder for the prompt template and provide the prompt template with placeholder data to the GenAI service 218. The GenAI service 218 can generate the text content based at least in part on the prompt template and placeholder data (e.g., a merchant identifier, estimated lost sales, industry identifier). The authorizations service 215 can transmit the text content in the notification. Then, the operations can proceed to the end of the depicted process.

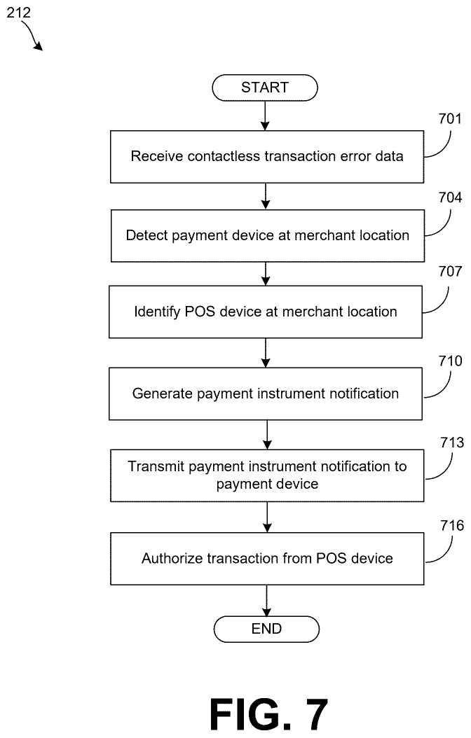

Turning now to FIG. 7, shown is a flowchart that provides one example of the operation of a portion of the authorization service 215. The flowchart of FIG. 7 provides merely an example of the many different types of functional arrangements that can be employed to implement the operation of the depicted portion of the authorization service 215. As an alternative, the flowchart of FIG. 7 can be viewed as depicting an example of elements of a method implemented within the network environment 100. In some examples, portions of or the entirely of the flowchart of FIG. 7 can be executed by the client application 251 and/or the wallet application 248.

Beginning with block 701, the authorization service 215 can receive contactless transaction error data from one or more devices, such as from various the POS devices 106, various payment devices 103 (e.g., payment card, mobile device, etc.). The contactless transaction error data (e.g., NFC transaction errors, BLUETOOTH errors) can include as unsupported transceiver (e.g., NFC transceiver, Bluetooth transceiver, Quick Response (QR) code errors, etc.) for POS device 106, malfunctioning POS device 106, no response from POS device 106, invalid payment credential, general error condition, and other suitable contactless transaction errors.

The contactless transaction error data can include one or more of an identifier for the POS device 106, such as a location identifier, a merchant identifier, a POS type, and other suitable POS identifying data.

In block 704, the authorization service 215 can determine a payment device 103 is situated at a merchant location based at least in part on location information provided by the payment device 103. In some examples, the payment device 103 is a client device with a location detection device and the location detection device provides location information, such as Global Position Satellite (GPS) coordinates, a location identifier from a beacon device, location triangulation information, receive strength signal indicators of wireless signals, and other suitable information. The payment device 103 can provide location information in real-time, near real-time, at a periodic interval, upon demand, or based at least in part on other suitable conditions.

In block 707, the authorization service 215 can identify a POS device 106 at the merchant location. The authorization service 215 can retrieve data associated with one or more POS devices 106 located at the merchant location. The POS device 106 can be identified in anticipation of the user desiring to make a purchase at the POS device 106.

In block 710, the authorization service 215 can generate a payment instrument notification for the payment device 103 based at least in part on the contactless transaction error data and the POS device 106. The payment instrument notification can include a recommendation to use an alternative payment credential 239 or a different transaction type (e.g., use a dip/insertion technique for an EMV chip-based payment card) based at least in part on the contactless transaction errors at the POS device 106.

In some examples, the authorization service 215 can generate the payment instrument notification based at least in part on executing the GenAI service 218, which can access a GenAI model. The GenAI model can return an output of a recommended alternative payment credential 239 and/or an alternative transaction type for the POS device 106.

In block 713, the authorization service 215 can transmit the payment instrument notification to the payment device for a transaction at the POS device 106 based at least in part on identifying an intent of the user to attempt the transaction at the POS device 106. The authorization service 215 can identify the intent of the user based at least in part on the proximity of the payment device to the POS device 106. For example, if the payment device 103 is less than a distance threshold from the POS device 106, the authorization service 215 can determine the payment device 106 is expected to make a transaction. The present location of the payment device 103 can determined from a location detection unit of the payment device 103, a beacon device located at the merchant location, and other suitable location devices. The authorization service 215 can compare the present location of the payment device 103 to a location of the POS device 106 to determine if the distance threshold is met.

Accordingly, the authorization service 215 can transmit real-time or near real-time payment instrument notifications of acceptable payment options (alternative payment credential 239 and/or an alternative transaction type) for a particular POS device 103 based least in part on the contactless transaction error data.

In some examples, during the initiation of the transaction, the payment device 103 can verify the identifier of the POS device 106 that was included in the payment instrument notification. Upon verification, the payment device 103 can transmit the alternative payment credential 239 to the POS device 106.

In block 716, the authorization service 215 can authorize the transaction based at least in part the alternative payment credential 239 received from the POS device 106. The alternative payment credential 239 can be extracted from an authorization request received from the POS device 106. Then, the authorization service 215 can proceed to the end of the depicted process.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies.

These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams of FIGS. 3-7 show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams of FIGS. 3-7 show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams of FIGS. 3-7 can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g, storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 203.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

1. A system, comprising:
a payment device comprising a processor, a memory, and a transceiver; and
machine-readable instructions stored in the memory that, when executed by the processor, cause the payment device to at least:
initiate a first transaction with a first wireless-enabled POS device using the transceiver;
generate a first payment credential for the first transaction based at least in part on first transaction data provided by the first wireless-enabled POS device;
transmit the first payment credential to the first wireless-enabled POS device using the transceiver; and
generate a transaction error based at least in part on an error code received from the first wireless-enabled POS device or an expiration of a time out period, the transaction error comprising an identifier for the first wireless-enabled POS device.

2. The system of claim 1, wherein the machine-readable instructions further cause the payment device to at least:
initiate a second transaction with a second wireless-enabled POS device;
generate a second payment credential for the second transaction based at least in part on second transaction data provided by the second wireless-enabled POS device; and
transmit the second payment credential for the second transaction and the transaction error for the first transaction to the second wireless-enabled POS device using the transceiver.

3. The system of claim 1, wherein the machine-readable instructions further cause the payment device to at least:
store the transaction error in the memory based at least in part on the generation of the transaction error.

4. The system of claim 1, wherein the payment device is an NFC-based payment card or an NFC-enabled mobile device.

5. The system of claim 1, wherein the machine-readable instructions further cause the payment device to at least:
transmit, over a network, the transaction error to a computing device based at least in part on the generation of the transaction error.

6. The system of claim 1, wherein the transaction error comprises at least one of an POS device error code, a null response from the first wireless-enabled POS device, or an invalid payment credential.

7. The system of claim 1, wherein the payment device is an NFC-based payment card or an NFC-enabled mobile device.

8. A method, comprising:
generating, by a payment device, a payment credential for a transaction with a wireless-enabled POS device;
transmitting, by the payment device, the payment credential to the wireless-enabled POS device using a transceiver of the payment device;
identifying, by the payment device, a transaction error based at least in part on an error code received from the wireless-enabled POS device or an expiration of a time out period;
generating, by the payment device, an alternative payment credential based at least in part on the transaction error; and
transmitting, by the payment device, the alternative payment credential to the wireless-enabled POS device using the transceiver of the payment device.

9. The method of claim 8, wherein the payment device is a near field communication (NFC)-enabled mobile device.

10. The method of claim 8, wherein the wireless-enabled POS device is an NFC-enabled POS device, and the alternative payment credential is transmitted during an NFC session with the NFC-enabled POS device.

11. The method of claim 8, wherein the alternative payment credential is retrieved from a different wallet application than the payment credential.

12. The method of claim 8, wherein the alternative payment credential comprises a decentralized identifier (DID) associated with a distributed ledger.

13. The method of claim 8, wherein generating the alternative payment credential is further based at least in part a wallet setting stored on the payment device.

14. The method of claim 8, wherein generating the alternative payment credential further comprises selecting the alternative payment credential based at least in part on transaction data provided by the wireless-enabled POS device.

15. (canceled)

16. (canceled)

17. (canceled)

18. (canceled)

19. (canceled)

20. (canceled)

21. A non-transitory, computer-readable medium, comprising machine-readable instructions that, when executed by a processor of a payment device, cause the payment device to at least:
initiate a first transaction with a first wireless-enabled POS device using a transceiver of the payment device;
generate a first payment credential for the first transaction based at least in part on first transaction data provided by the first wireless-enabled POS device;
transmit the first payment credential to the first wireless-enabled POS device using the transceiver; and
generate a transaction error based at least in part on an error code received from the first wireless-enabled POS device or an expiration of a time out period, the transaction error comprising an identifier for the first wireless-enabled POS device.

22. The non-transitory, computer-readable medium of claim 21, wherein the machine-readable instructions further cause the payment device to at least:
initiate a second transaction with a second wireless-enabled POS device;
generate a second payment credential for the second transaction based at least in part on second transaction data provided by the second wireless-enabled POS device; and
transmit the second payment credential for the second transaction and the transaction error for the first transaction to the second wireless-enabled POS device using the transceiver.

23. The non-transitory, computer-readable medium of claim 21, wherein the machine-readable instructions further cause the payment device to at least:
store the transaction error in the memory based at least in part on the generation of the transaction error.

24. The non-transitory, computer-readable medium of claim 21, wherein the payment device is an NFC-based payment card or an NFC-enabled mobile device.

25. The non-transitory, computer-readable medium of claim 21, wherein the machine-readable instructions further cause the payment device to at least:
transmit, over a network using the transceiver, the transaction error to a computing device based at least in part on the generation of the transaction error.

26. The non-transitory, computer-readable medium of claim 21, wherein the transaction error comprises at least one of an POS device error code, a null response from the first wireless-enabled POS device, or an invalid payment credential.
